(19) United States
(12) Patent Application Publication
(10) Pub. No.: US 2025/0253722 A1
(43) Pub. Date: Aug. 7, 2025

(54) MOTOR

(71) Applicant: TOYOTA JIDOSHA KABUSHIKI KAISHA, Toyota-shi (JP)

(72) Inventors: Hirokazu NISHIJIMA, Ebina-shi (JP); Kazunori HARIMA, Mishima-shi (JP); Hiroaki EBUCHI, Hadano-shi (JP)

(73) Assignee: TOYOTA JIDOSHA KABUSHIKI KAISHA, Toyota-shi (JP)

(21) Appl. No.: 18/931,333

(22) Filed: Oct. 30, 2024

(30) Foreign Application Priority Data
Feb. 5, 2024 (JP) 2024-015788

(51) Int. Cl. H02K 1/20; H02K 9/193

(52) U.S. Cl. CPC H02K 1/20; H02K 9/193

(57) ABSTRACT

The motor includes a rotor, a stator core around which a coil is wound, and an oil passage extending in a direction of a rotation axis of the rotor inside the stator core, and the oil passage is formed to be inclined at a predetermined angle with respect to the rotation axis.

### CROSS-REFERENCE TO RELATED APPLICATION

This application claims priority to Japanese Patent Application No. 2024-015788 filed on Feb. 5, 2024, incorporated herein by reference in its entirety.

### BACKGROUND

### 1. Technical Field

The present disclosure relates to a motor.

### 2. Description of Related Art

Japanese Unexamined Patent Application Publication No. 2009-240113 (JP 2009-240113 A) discloses a configuration in which an oil passage extending parallel to a rotation axis direction of a rotor is formed inside a stator core.

### SUMMARY

Since the oil passage extends parallel to the rotation axis direction in the technology proposed in JP 2009-240113 A, the magnetic flux density is different at each specific location where the oil passage is formed. There is a possibility that the performance of the motor decreases or vibration is exacerbated due to imbalance.

The present disclosure has been made in view of the above, and an object thereof is to provide a motor capable of suppressing a decrease in the performance of the motor and exacerbation of vibration due to imbalance.

A motor according to the present disclosure includes a rotor, a stator core on which a coil is wound, and an oil passage extending in a direction of a rotation axis of the rotor in an inside of the stator core. The oil passage is inclined at a predetermined angle with respect to the rotation axis.

According to the present disclosure, the oil passage is inclined at the predetermined angle with respect to the rotation axis direction of the rotor. Therefore, it is possible to suppress variations in each phase of the stator core, and to suppress the decrease in the performance of the motor and the exacerbation of vibration due to imbalance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating an example of a configuration of a motor according to an embodiment;

FIG. 2 is a cross-sectional view of the motor according to the embodiment taken along A-A line of FIG. 1; and

FIG. 3 is a front view illustrating a stator core and a coil of the motor according to the embodiment as viewed from the front.

### DETAILED DESCRIPTION OF EMBODIMENTS

A motor according to an embodiment of the present disclosure will be described with reference to the drawings. Incidentally, the constituent elements in the following embodiments include those that can be easily replaced by a person skilled in the art or those that are substantially the same.

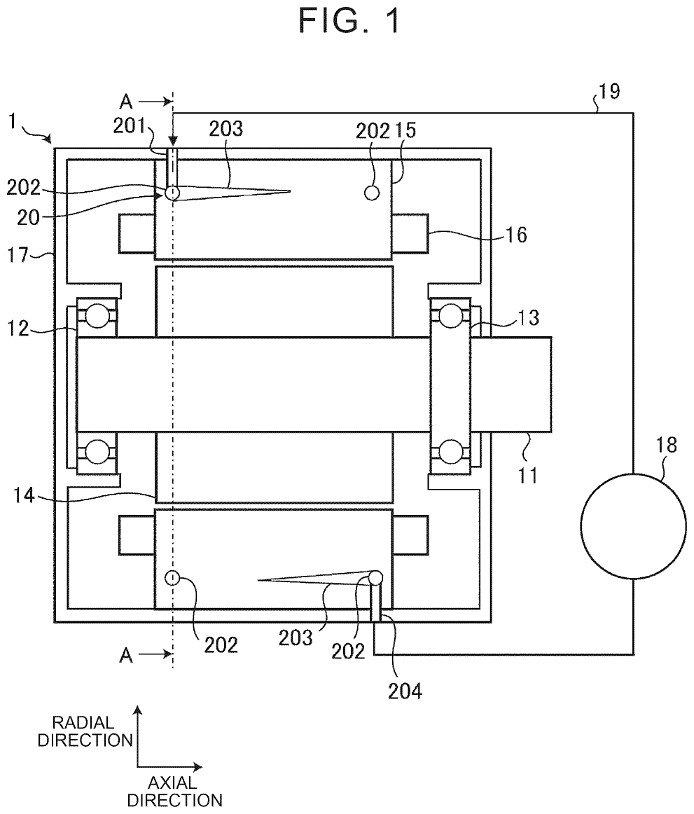

A motor according to an embodiment will be described with reference to FIGS. 1 to 3. The motor according to the embodiment is used, for example, as a power source of a vehicle. The motor according to the embodiment is mounted on, for example, hybrid electric vehicle (HEV), plug-in hybrid electric vehicle (PHEV), or the like. Further, the motor according to the embodiment may be mounted on, for example, fuel cell electric vehicle (FCEV), battery electric vehicle (BEV), or the like.

As shown in FIG. 1, the motor 1 includes a shaft 11, a pair of bearings 12 and 13, a rotor 14, a stator core 15, a coil 16, a case 17, a refrigerant pump 18, a refrigerant passage 19, and an oil passage 20. In the motor 1, the refrigerant pump 18, the refrigerant passage 19, and the oil passage 20 constitute a closed circuit for cooling passing through the inside of the stator core 15.

The shaft 11 is attached to the rotor 14 via a pair of bearings 12 and 13. The shaft 11 is fixed to the rotor 14 and rotates integrally with the rotor 14. The bearings 12 and 13 are for supporting the shaft 11.

The rotor 14 is formed in a cylindrical shape. A shaft 11 is attached to the inside of the cylinder of the rotor 14.

The stator core 15 is formed in a cylindrical shape and is disposed radially outward of the rotor 14. A plurality of teeth protruding radially inward are provided inside the cylinder of the stator core 15, and the coil 16 is wound around each tooth. An oil passage 20 is provided inside the stator core 15.

The stator core 15 is constituted by a dust core. Here, in general motors such as JP 2009-240113 A, the stator core is constituted by a laminated steel plate. When an oil passage for cooling is provided in a stator core (hereinafter, referred to as “laminated core”) made of such a laminated steel sheet, leakage of the refrigerant is worried, and therefore, the usable refrigerant is also limited. In laminated cores, for example, from the viewpoint of insulating, but Automatic Transmission Fluid (ATF) is used as a cooling oil as a refrigerant, there is a problem that the cooling efficiency is inferior compared to the coolant. Further, when an oil passage for cooling is provided in the laminated core, the following problems arise.
(1) Since the degree of freedom in the shape of the oil passage is small due to the manufacturing restriction, the performance (torque, vibration, and the like) of the motor may deteriorate due to the presence of the oil passage.
(2) In the laminated core, since there is a gap between the steel plate and the steel plate, the oil passage cannot be sealed.
(3) Since a manufacturing method in which a press-molded steel sheet is laminated to form a laminated core is mainly used, it is difficult to provide an oil passage other than the oil passage parallel to the lamination direction (axial direction of the rotor).

As described above, in the laminated core, since the oil passage extends parallel to the rotation axis direction, the magnetic flux density differs for each specific location where the oil passage is formed, and there is a possibility that deterioration in performance of the motor and deterioration in vibration due to imbalance occur.

On the other hand, since the stator core 15 according to the embodiment is constituted by the dust core, the manufacturing restriction of the above (1) is eliminated, and the degree of freedom in shape of the oil passage 20 is increased. Further, since there is no gap in the stator core 15 as described in (2) above, it is possible to seal the oil passage. In addition, unlike the above (3), it is possible to easily provide the oil passage 20 which is not parallel to the axial direction of the rotor 14, for example, is inclined with respect to the axial direction. Details of the oil passage 20 will be described later.

The case 17 is for accommodating the components (the shaft 11, the bearings 12 and 13, the rotor 14, the stator core 15, and the coil 16) of the motor 1. The refrigerant pump 18 is for supplying a refrigerant (for example, coolant) to the refrigerant passage 19 and the oil passage 20. The refrigerant passage 19 is a passage for supplying the refrigerant supplied from the refrigerant pump 18 to the oil passage 20.

The oil passage 20 is provided inside the stator core 15. The oil passage 20 extends in the direction of the rotation axis of the rotor 14 inside the stator core 15. Further, the oil passage 20 is formed at the same time when the stator core 15 is shaped by, for example, a die press of a green compact. Specifically, as shown in FIGS. 1 to 3, the oil passage 20 includes an oil passage inlet 201, a first oil passage 202, a plurality of second oil passages 203, and an oil passage outlet 204.

As shown in FIG. 1, the oil passage inlet 201 is an inlet through which the refrigerant flows into the oil passage 20, and is connected to the refrigerant passage 19.

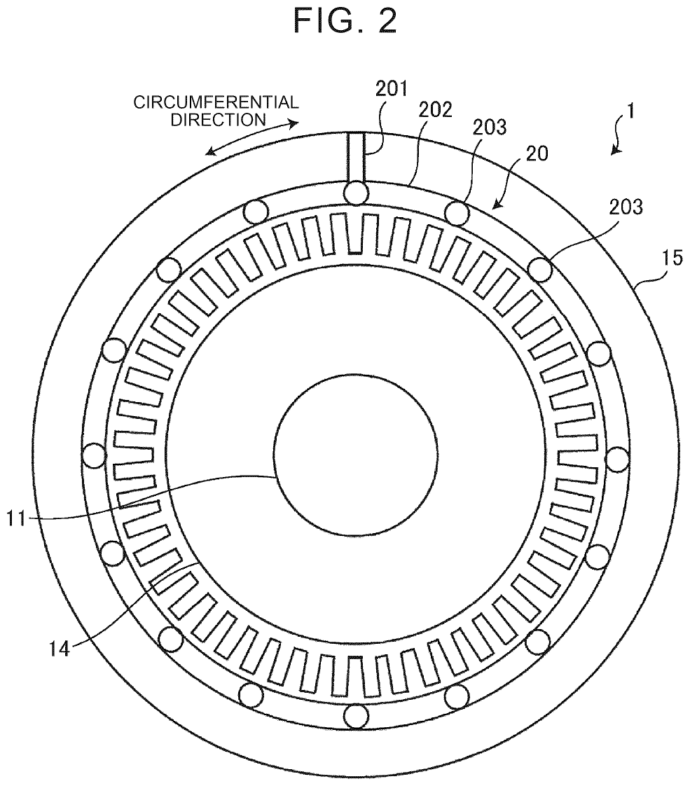

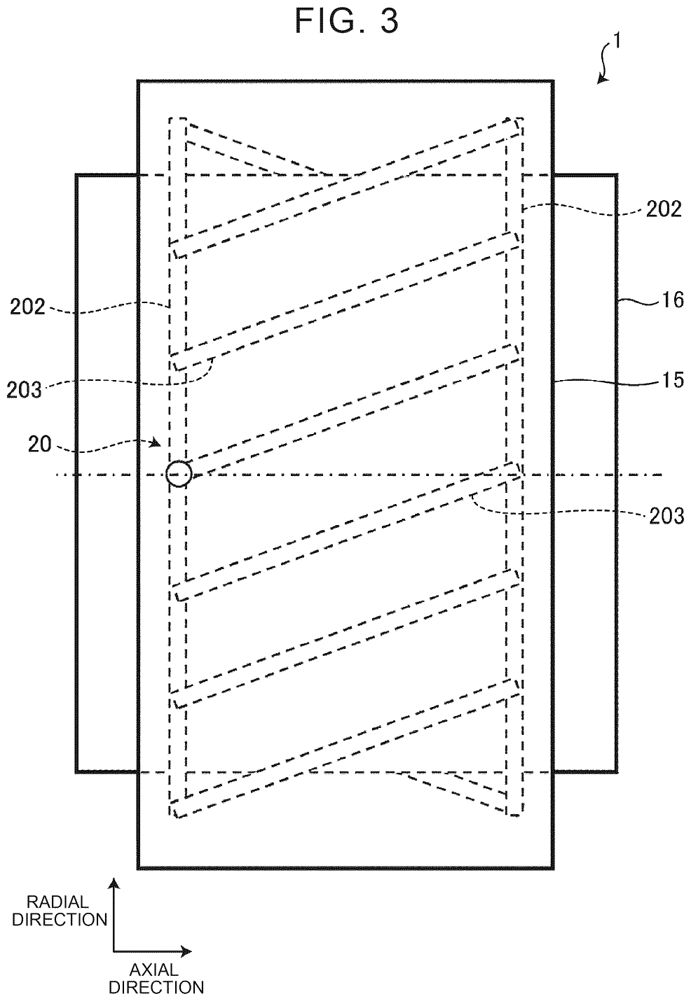

As shown in FIG. 2, the first oil passage 202 is formed in the circumferential direction of the stator core 15. The first oil passage 202 is connected to the oil passage inlet 201, the second oil passage 203, and the oil passage outlet 204. In addition, as shown in FIG. 3, there are a total of two first oil passages 202, one connected to the oil passage inlet 201 (see FIG. 2), and one connected to the oil passage outlet 204.

The second oil passage 203 is formed in the direction of the rotation axis of the rotor 14, and specifically, is formed to be inclined at a predetermined angle with respect to the rotation axis of the rotor 14. The inclination angle of the second oil passage 203 with respect to the rotation axis of the rotor 14 and the number of the second oil passages 203 are not particularly limited, and may be appropriately changed in accordance with the performance required for the motor 1. In the example of FIG. 3, the plurality of second oil passages 203 is formed parallel to each other (the same inclination angle), but the inclination angle of each second oil passage 203 may be appropriately changed in accordance with the performance required for the motor 1.

As shown in FIG. 1, the oil passage outlet 204 is an outlet through which the refrigerant flows out of the oil passage 20, and is connected to the refrigerant passage 19.

According to the motor according to the embodiment described above, by forming the oil passage 20 at a predetermined angle with respect to the rotation axis direction of the rotor 14, it is possible to suppress variations in the phase of the stator core 15, and to suppress deterioration in performance of the motor 1 and deterioration in vibration caused by imbalance.

Further, in the motor according to the embodiment, by using the stator core 15 integrally molded by the dust core, the refrigerant pump 18, in the closed circuit of the cooling comprising the refrigerant passage 19 and the oil passage 20, it is possible to flow a refrigerant having a high cooling effect. Further, in the motor according to the embodiment, the cross section of the stator core 15 can be cooled as uniformly as possible by the first oil passage 202 in the circumferential direction, which is difficult in the laminated core. Further, the refrigerant taken in from the oil passage inlet 201 can be spread to the plurality of second oil passages 203 formed in the axial direction.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A motor comprising:
a rotor,
a stator core on which a coil is wound; and
an oil passage extending in a direction of a rotation axis of the rotor in an inside of the stator core, wherein the oil passage is inclined at a predetermined angle with respect to the rotation axis.

2. The motor according to claim 1, wherein the stator core is a powder magnetic core.
